(19) United States
(12) Patent Application Publication
(10) Pub. No.: US 2011/0194531 A1
(43) Pub. Date: Aug. 11, 2011

(54) METHOD OF NETWORK RE-ENTRY IN A BROADBAND WIRELESS ACCESS SYSTEM

(75) Inventors: Gi Won PARK, Anyang-si (KR); Yong Ho Kim, Incheon-si (KR); Ki Seon Ryu, Sungnam-si (KR)

(73) Assignee: LG ELECTRONICS INC.

(21) Appl. No.: 13/023,456

(22) Filed: Feb. 8, 2011

Related U.S. Application Data
(60) Provisional application No. 61/302,478, filed on Feb. 8, 2010.
(60) Provisional application No. 61/306,950, filed on Feb. 23, 2010.

(30) Foreign Application Priority Data
Nov. 5, 2010 (KR) 10-2010-0109519

(51) Int. Cl. H04W 36/00; H04W 40/00

(52) U.S. Cl. 370/331; 370/328

(57) ABSTRACT

A method of performing network re-entry of a mobile station based on restart of a base station and an apparatus for performing the same are disclosed. The method comprises the steps of receiving a first message from a base station, the first message including a restart count of which value is varied whenever the base station is restarted; comparing the restart count value with a count value previously stored; and transmitting a second message to the base station if the count values are different from each other, the second message including a first identifier for identifying the mobile station in respect of connection information (context) of the mobile station and a ranging purpose indication field set to a value indicating network re-entry due to restart of the base station.

### CROSS-REFERENCE TO RELATED APPLICATIONS

Pursuant to 35 U.S.C. §119, this application claims the benefit of earlier filing date and right of priority to Korean Application No. 10-2010-0109519, filed on Nov. 5, 2010, and U.S. Provisional Application Ser. Nos. 61/302,478, filed on Feb. 8, 2010, and 61/306,950, filed on Feb. 23, 2010, the contents of which are hereby incorporated by reference herein in their entirety.

### BACKGROUND OF THE INVENTION

1. Field of the Invention

The present invention relates to a broadband wireless access system, and more particularly, to a method of efficient network re-entry of a mobile station based on restart of a base station and an apparatus for performing the same.

2. Discussion of the Related Art

In a general mobile communication system, uplink data may not be transmitted from a mobile station for a certain time period or feedback (ACK or NACK) of downlink data may not be transmitted to a base station. At this time, the base station can facilitate network re-entry of the mobile station by triggering a resource retain timer and storing connection information (context) of the mobile station. This method is provided implicitly in the general mobile communication system. Since the timing and basis that the base station determines that the mobile station has lost network coverage are not definite, the base station should unnecessarily store the connection information of the mobile station.

In this respect, in a general IEEE 802.16m system, a deregistration with context retention (DCR) mode and a coverage loss recovery mode are defined due to a problem that may occur due to non-synchronization between a serving base station and a mobile station if the mobile station loses service coverage of the serving base station.

In general, only if the mobile station detects coverage loss and performs network re-entry or performs network re-entry in a DCR mode, a network re-entry process has been optimized by including a context retention identifier (CRID) in a ranging request (AAI_RNG-REQ) message.

However, if a critical error occurs in the base station or in case of need on management, the base station (ABS) may be restarted. Since the connection information of the mobile station may be lost from the base station even in the case that the base station is restarted, the mobile station needs to detect whether the base station is restarted. Also, it is required that a procedure of optimizing a network re-entry process of the mobile station should be defined.

### SUMMARY OF THE INVENTION

Accordingly, the present invention is directed to a method of network re-entry in a broadband wireless access system, which substantially obviates one or more problems due to limitations and disadvantages of the related art.

An object of the present invention is to provide a method of determining in a mobile station whether a base station is restarted, and an apparatus for performing the method.

Another object of the present invention is to provide an efficient network re-entry procedure and an apparatus for performing the procedure if a mobile station detects whether a base station is restarted.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of performing network re-entry of a mobile station in a broadband wireless access system comprises the steps of receiving a first message from a base station, the first message including a restart count of which value is varied whenever the base station is restarted; comparing the restart count value with a count value previously stored; and transmitting a second message to the base station if the count values are different from each other, the second message including a first identifier for identifying the mobile station in respect of connection information (context) of the mobile station and a ranging purpose indication field set to a value indicating network re-entry due to restart of the base station.

In this case, the method further comprises the step of receiving a third message from the base station, the third message including optimization information indicating a process that can be omitted during the network re-entry.

Also, the method further comprises the steps of transmitting a handover ranging code to the base station, receiving a fourth message from the base station, the fourth message including the transmitted result of the handover ranging code, and receiving uplink resource allocation information from the base station if the transmitted result is successful, wherein the step of transmitting a second message is performed using uplink resources indicated by the uplink resource allocation information.

Preferably, the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

Preferably, the first identifier is context retention identifier (CRID), the value indicating network re-entry due to restart of the base station is 0b1000, and the optimization information is a handover (HO) process optimization field.

In another aspect of the present invention, a method of performing network re-entry of a base station in a broadband wireless access system due to restart of the base station comprises the steps of restarting the base station; increasing a restart count value; broadcasting a first message, which includes the increased restart count value; and receiving a second message from the mobile station, the second message including a first identifier for identifying the mobile station in respect of connection information (context) of the mobile station and a ranging purpose indication field set to a value indicating network re-entry due to restart of the base station.

In this case, the method further comprises the steps of requesting a network entity, which stores the connection information of the mobile station, of the connection information of the mobile station; and transmitting a third message to the mobile station, the third message including optimization information configured in accordance with the received connection information.

Preferably, the method further comprises the steps of receiving a handover ranging code from the mobile station, transmitting a fourth message to the mobile station, the fourth message including the transmitted result of the handover ranging code, and transmitting uplink resource allocation information to the mobile station if the transmitted result is successful, wherein the step of receiving a second message is performed using uplink resources indicated by the uplink resource allocation information.

Preferably, the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

Preferably, the first identifier is context retention identifier (CRID), the value indicating network re-entry due to restart of the base station is 0b1000, and the optimization information is a handover (HO) process optimization field.

In other aspect of the present invention, a mobile station apparatus of performing network re-entry in a broadband wireless access system comprises a processor; and a radio frequency (RF) module for transmitting and receiving a radio signal to and from the outside under the control of the processor, wherein, if a first message is received from a base station, the first message including a restart count of which value is varied whenever the base station is restarted, the processor compares the restart count value with a count value previously stored, and transmits a second message to the base station if the count values are different from each other, the second message including a first identifier for identifying the mobile station in respect of connection information (context) of the mobile station and a ranging purpose indication field set to a value indicating network re-entry due to restart of the base station.

In this case, the processor is controlled to receive a third message from the base station, the third message including optimization information indicating a process that can be omitted during the network re-entry.

Also, the processor is controlled to transmit a handover ranging code to the base station, receives a fourth message from the base station, the fourth message including the transmitted result of the handover ranging code, and receives uplink resource allocation information from the base station if the transmitted result is successful, the second message being transmitted to the base station through uplink resources indicated by the uplink resource allocation information.

Preferably, the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

Preferably, the first identifier is context retention identifier (CRID), the value indicating network re-entry due to restart of the base station is 0b1000, and the optimization information is a handover (HO) process optimization field.

According to the embodiments of the present invention, the following advantages can be obtained.

First of all, the mobile station can efficiently determine whether the corresponding base station is restarted by comparing restart counts of a system configuration descriptor (AAI_SCD) message broadcasted from the base station through the network re-entry procedure disclosed in the embodiments of the present invention.

Second, through the network re-entry procedure disclosed in the embodiments of the present invention, the mobile station can perform the network re-entry procedure optimized for the base station that has been restarted.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating an example of a method of detecting coverage loss of a base station, which can be applied to the embodiments of the present invention;

FIG. 2 is a diagram illustrating an example of a procedure of determining in a mobile station whether a base station is restarted in accordance with one embodiment of the present invention;

FIG. 3 is a diagram illustrating an example of a network re-entry procedure of a mobile station according to one embodiment of the present invention; and

FIG. 4 is a block diagram illustrating an example of a transmitter and a receiver according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a wireless access system. Hereinafter, the embodiments of the present invention disclose methods of efficient network re-entry in a mobile station after a base station is restarted and an apparatus for performing the methods.

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

In the description of drawings, procedures or steps that may make the subject matter of the present invention obscure will not be disclosed. Also, procedures or steps that may be understood by the person with ordinary skill in the art will not be disclosed.

In this specification, the embodiments of the present invention have been described based on the data transmission and reception between a base station and a mobile station. In this case, the base station means a terminal node of a network, which performs direct communication with the mobile station. A specific operation which has been described as being performed by the base station may be performed by an upper node of the base station as the case may be.

In other words, it will be apparent that various operations performed for communication with the mobile station in the network which includes a plurality of network nodes along with the base station may be performed by the base station or network nodes other than the base station. The base station (BS) may be replaced with terms such as a fixed station, Node B, eNode B (eNB), and an access point (AP). Also, the mobile station may be replaced with terms such as a user equipment (UE), a subscriber station (SS), a mobile subscriber station (MSS), and a mobile terminal (MT).

Furthermore, a transmitting side means a fixed and/or mobile node that provides data services or voice services while a receiving side means a fixed and/or mobile node that receives data services or voice services. Accordingly, in an uplink, the mobile station could be a transmitting side while the base station could be a receiving side. Likewise, in a downlink, the mobile station could be a receiving side while the base station could be a transmitting side.

Meanwhile, in the present invention, examples of the mobile station include a personal digital assistant (PDA), a cellular phone, a personal communication service (PCS) phone, a global system for mobile (GSM) phone, a wideband CDMA (WCDMA) phone, and a mobile broadband system (MBS) phone.

The embodiments according to the present invention can be implemented by various means, for example, hardware, firmware, software, or their combination.

If the embodiment according to the present invention is implemented by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method according to the embodiments of the present invention can be implemented by a type of a module, a procedure, or a function, which performs functions or operations described as above. For example, a software code may be stored in a memory unit and then may be driven by a processor. The memory unit may be located inside or outside the processor to transmit and receive data to and from the processor through various means which are well known.

The embodiments of the present invention can be supported by standard documents disclosed in at least one of wireless access systems, i.e., IEEE 802 system, 3GPP system, 3GPP LTE system, and 3GPP2 system. Namely, among the embodiments of the present invention, steps or parts which are not described to clarify the technical features of the present invention can be supported by the above standard documents. Also, all terminologies disclosed herein can be described by the above standard documents. Particularly, the embodiments of the present invention can be supported by one or more standard documents of IEEE 802.16 system, i.e., P802.16e-2004, P802.16e-2005, P802.16Rev2, and IEEE P802.16m.

Specific terminologies hereinafter used in the embodiments of the present invention are provided to assist understanding of the present invention, and various modifications can be made in the specific terminologies within the range that they do not depart from technical spirits of the present invention.

In this specification, the present invention will be described based on the IEEE 802.16 system. In particular, it is assumed that a mobile station is an advanced mobile station (AMS) that satisfies specifications defined in the IEEE 802.16m standard and a base station is an advanced base station (ABS) of the same standard as that of the AMS.

Coverage Loss

Since a restart status of a base station is similar to a coverage loss status, “coverage loss” will first be defined in this specification.

Coverage loss means that temporary signal loss occurs due to fading generated as a mobile station moves to a zone that loses a service zone (i.e., coverage) of a base station.

Next, an active base station timer (active_ABS_timer) will be defined.

The active base station timer means a timer maintained by the base station for each of mobile stations. The active base station timer can be started as initial network entry is completed based on completion of registration request/response (AAI_REG-REQ/AAI_REG-RSP) message exchange between the mobile station and the base station. Alternatively, the active base station timer can be started as network re-entry is completed based on handover (HO) process optimization (or Reentry process optimization) included in a ranging response message. The active base station timer can be reset when the base station receives data from the mobile station. At this time, examples of the data include medium access control protocol data unit (MAC PDU (MPDU) and feedback information.

Also, the active base station timer may be started if a corresponding base station fails to receive a handover completion notification message from a network through a backbone network until a previously set time when the mobile station, which uses the corresponding base station as a serving base station, performs handover to another target base station. At this time, the previously set time is preferably the time indicated by ranging initiation deadline (Ranging_Initiation_Deadline) information.

Next, a resource retain timer will be defined.

If the active base station timer (Active_ABS_timer) expires for a specific mobile station, the base station performs a predetermined procedure for determining coverage loss of the corresponding mobile station. This procedure will be referred to as “coverage loss detection”. The procedure of coverage loss detection will later be described in detail. If there is no response from the mobile station even after the procedure of coverage loss detection, the base station can start the resource retain timer. If the resource retain timer expires, the base station can release context of the corresponding mobile station.

Also, an active mobile station timer (Active AMS Timer) will be defined.

In the same manner as the aforementioned active base station timer, the active mobile station timer can be started as initial network entry is completed based on completion of registration request/response (AAI_REG-REQ/AAI_REG-RSP) message exchange between the mobile station and the base station. Alternatively, the active mobile station timer can be started as network re-entry is completed based on handover (HO) process optimization included in a ranging response message. The mobile station can identify that its connection context is retained in the network for the time when the active mobile station timer is maintained (i.e., until the active mobile station timer expires).

Next, the context retention identifier (CRID) will be defined.

The CRID can be allocated from the base station to the mobile station through the registration response (AAI_REG-RSP) message. The CRID is an identifier that can be used to identify the corresponding mobile station from the network (particularly, an entity (for example, authenticator ASN-GW) that retains connection information (context) of the corresponding mobile station or the base station). Also, the CRID may be used to identify the mobile station that is operated in a deregistration with context retention (DCR) mode. This CRID can be allocated to the mobile station through the registration response message, or may be updated through the ranging response (AAI_RNG-RSP) message during network re-entry or the deregistration response (AAI_DREG-RSP) message during DCR mode entry.

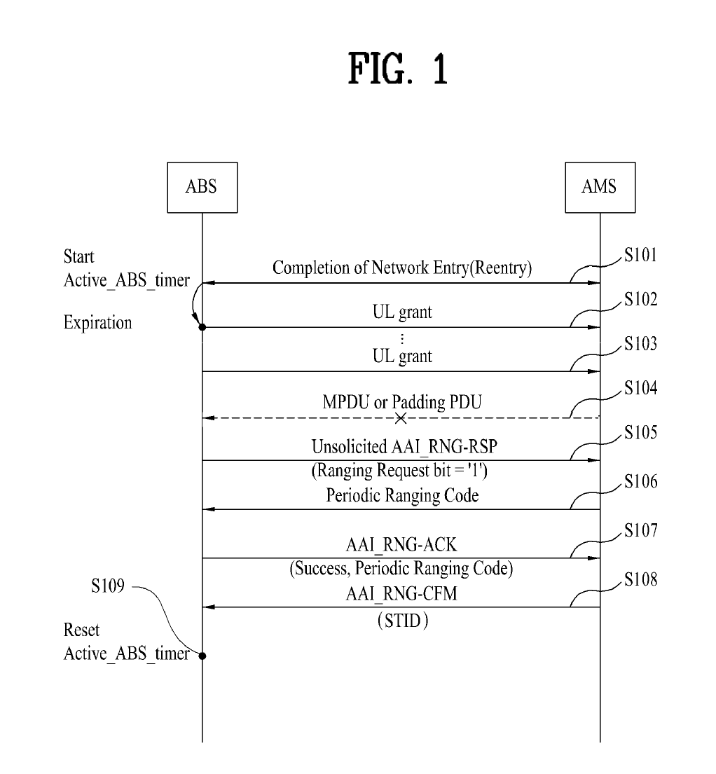

Hereinafter, methods of detecting coverage loss of the mobile station and the base station by using the aforementioned timers will be described with reference to FIG. 1.

FIG. 1 is a diagram illustrating an example of a method of detecting coverage loss of a base station, which can be applied to the embodiments of the present invention.

Referring to FIG. 1, first of all, in accordance with completion of initial network entry or completion of network re-entry, the base station starts the active base station timer for the corresponding mobile station while the mobile station starts the active mobile station timer (S101).

At this time, initial network entry can be completed by completion of registration request/response (AAI_REG-REQ/AAI_REG-RSP) message exchange between the mobile station and the base station, and network re-entry can be completed depending on handover (HO) process optimization included in the ranging response message. In case of initial network entry, context retention identifier (CRID) can be allocated to the mobile station through the registration response (AAI_REG-RSP) message. In case of network re-entry, new CRID can be allocated to the mobile station through the ranging response message (AAI_RNG-RSP) message.

At this time, if the active base station timer expires for the corresponding mobile station, the base station allocates uplink (UL) grant burst to identify the status of the corresponding mobile station (S102).

The mobile station transmits padding PDU or MPDU to the base station through the allocated UL grant. If the base station receives the padding PDU or MPDU, the active base station timer is reset.

However, the base station may receive none of data (MAC PDU that includes data or padding byte) from the mobile station through uplink resources indicated by a predetermined number of contiguous UL grants (for example, ten UL grants) (S103, S104).

In this case, the base station transmits an unsolicited ranging response (AAI_RNG-RSP) message to the mobile station so that the mobile station performs periodic ranging based on a periodic ranging code. To this end, the base station sets a ranging request bit of the ranging response message to ‘1’ (S105).

At this time, the base station can start a timer (for example, retry timer or T58 timer) that indicates standby time for receiving a message for ranging confirmation.

The mobile station transmits the periodic ranging code to the base station in accordance with a ranging request of the base station (S106).

The base station transmits a ranging acknowledgement (AAI_RNG-ACK) message to the mobile station in response to the ranging code (S107). At this time, the ranging acknowledgement message may include information (ranging status) indicating ranging success or failure and the ranging code transmitted from the mobile station.

The mobile station transmits a ranging confirmation (AAI_RNG-CFM) message to the base station in response to the ranging acknowledgement message (S108). At this time, the mobile station may include its station ID (STID) in the ranging confirmation message.

If the base station receives the ranging confirmation message transmitted from the mobile station, it updates the active base station timer (S109).

In the mean time, if physical (PHY) layer synchronization, downlink synchronization or uplink synchronization with the base station is failed, the mobile station can determine it as the coverage loss status. In more detail, if the mobile station fails to continuously receive a super frame header (SFH) equivalent to the number of previously set times (N_{LOST-SFH}), from the base station, it can determine the failure as coverage loss from the corresponding base station.

Procedure of Performing Detection of Restart of Base Station and Network Re-Entry

According to one embodiment of the present invention, the mobile station determines whether the base station is restarted, if the mobile station determines that the base station is restarted, a method of efficient network entry will be disclosed.

First of all, a method of determining whether a base station is restarted in accordance with the embodiment of the present invention will be described.

If a critical error occurs in the base station, or in case of need on management, the base station can be restarted. If the base station is restarted, it may previously notify the mobile station that the base station will be restarted, through a predetermined broadcast message. However, if the restart process is performed while the mobile station in a sleep mode is being operated in a sleep window, or in case of the aforementioned coverage loss status, the mobile station may fail to recognize whether the base station is restarted.

Accordingly, this embodiment suggests that the base station performs counts indicating the number of restart times whenever the base station is restarted so that the mobile station can determine whether the base station is restarted, and the counts are broadcasted through a predetermined broadcast message.

The counts indicating the number of restart times will be referred to as “restart counts (or BS_Restart_Count)”. Also, a system configuration descriptor (AAI_SCD) message can be used as the broadcast message for notifying the mobile stations of the restart count value. The AAI_SCD message is a message periodically broadcasted from the base station to define system configuration of the corresponding base station. An example of the AAI_SCD message that includes the restart count value according to this embodiment will be described with reference to Table 1 below.

Table 1 illustrates a part of AAI_SCD message format according to one embodiment of the present invention.

TABLE 1

| | Attributes/Array of | | | | |
|---|---|---|---|---|---|
| MO | attributes | | Size (bits) | Value/Note | Conditions |
| M | Configuration Change Count | | 4 | The value is increased whenever the consents | NA. |
| | | | | of [symbol] message is changed The value | |
| | | | | coils over from 0 to 15 | |
| M | BS_Restart_Count | | 4 | The value is increment by one whenever | NA. |
| | | | | BS [symbol] The value both over from 0 to | |
| | | | | 15 | |
| M | SA_PreamblePartitionforBStype | | 20 | Indicate the SA-Preamble partition information. | NA. |
| | | | | Each 4 bit represents a partition | |
| | | | | range for each cell type as defined in | |
| | | | | 16.2.6.12 and Table 823 | |
| M | Trigger definitions | | Variable | Refer to Table 772 | NA. |
| | NormalizedCTNR | | | | |
| O | OL_MIMO_Parameters | OL- | 1 | 0 or 1 | OL MIMO |
| | | Region- | | | parameters |
| | | Type [symbol] - | | | |
| | | [symbol] | | | |
| O | OL MIMO Parameters | OL- | 4 | 0 to 15 | OL MIMO |
| | | Region- | | | parameters |
| | | TypeI- | | | |
| | | M.R.U. | | | |
| | | Size | | | |

[symbol]

indicates data missing or illegible when filed

Referring to Table, the AAI_SCD message includes a BS_Restart_Count field that increases a count value by 1 whenever the base station is restarted within a predetermined range (for example, from 0 to 15) and notifies an entity (for example, mobile station or relay node), which receives the AAI_SCD message, of restart count of the base station.

The mobile station periodically receives the AAI_SCD message broadcasted from the base station and stores the BS_Restart_Count field value. Afterwards, if the AAI_SCD message is received, the mobile station compares the previously stored BS_Restart_Count field value with the BS_Restart_Count field value of the currently received AAI_SCD message. As a result, if the BS_Restart_Count field values are different from each other, the mobile station can determine that the base station is restarted.

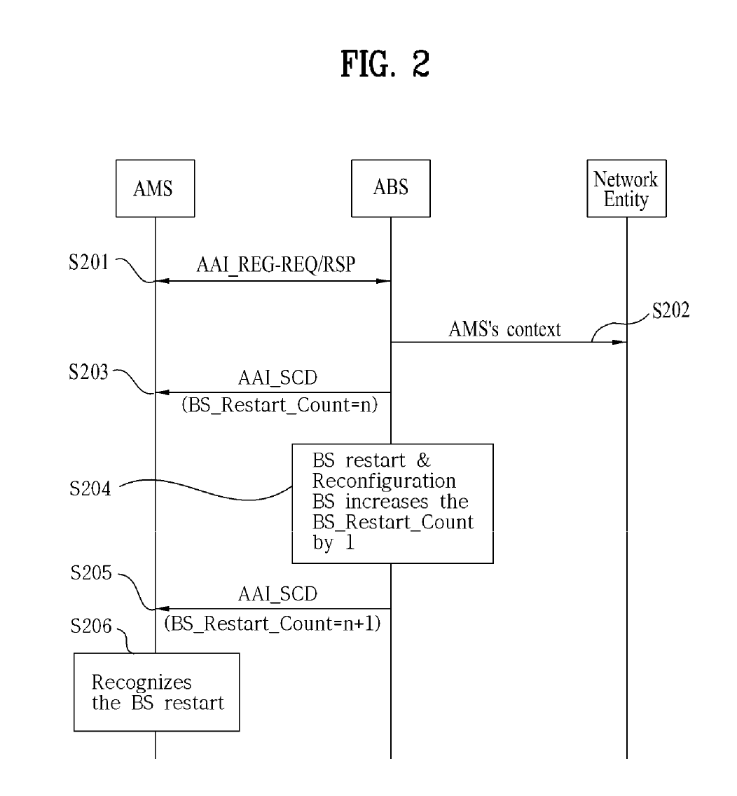

The aforementioned operation procedure will be described with reference to FIG. 2.

FIG. 2 is a diagram illustrating an example of a procedure of determining in a mobile station whether a base station is restarted in accordance with one embodiment of the present invention.

Referring to FIG. 2, the mobile station performs registration request/response (AAI_REG-REQ/AAI_REG-RSP) message exchange with the base station as a procedure of initial network entry, and in this case, context retention identifier (CRID) can be allocated to the mobile station (S201).

Afterwards, the base station forwards connection information (context or static context) of the corresponding mobile station to a predetermined network entity (S202). At this time, transmission of the connection information of the mobile station may be performed by the base station as initial network entry/network re-entry of the mobile station is completed. Alternatively, after the base station determines restart, transmission of the connection information of the mobile station may be performed before the base station is restarted.

The base station periodically broadcasts its restart count (supposed to be ‘n’) through the AAI_SCD message, and the mobile station stores the acquired restart count value (S203).

If the base station is restarted due to a critical error or need on management, it increases the restart count value by 1 (S204), and broadcasts the restart count value of the AAI_SCD message by increasing it by 1 (i.e., BS_Restart_Count=‘n+1’) (S205).

The mobile station compares the restart count value (n+1) received through the AAI_SCD message in the step S205 with the previously stored restart count value (n), and determines that the base station is restarted as the restart count values are different from each other (S206).

Hereinafter, if it is determined that the base station is restarted, a network re-entry procedure of the mobile station will be described.

If the mobile station detects restart of the base station through the aforementioned method, it performs the network re-entry procedure by using a handover ranging code. At this time, if the base station can acquire the connection information of the mobile station from the network entity that stores the connection information of the corresponding mobile station, the network re-entry procedure can be optimized. Accordingly, this embodiment suggests that the ranging request (AAI_RNG-REQ) message transmitted for the network re-entry procedure from the mobile station includes CRID. Also, this embodiment suggests that a ranging purpose indication field of the ranging request message is set to a value (for example, 0b1000) indicating network re-entry based on the different restart counts. At this time, the value indicating network re-entry based on the different restart counts may be the same as a value indicating network re-entry based on a recovery procedure of coverage loss. A structure of the AAI_RNG-REQ message for performing network re-entry will be described with reference to Table 2 and Table 3.

Table 2 illustrates a part of the AAI_RNG-REQ message format according to one embodiment of the present invention.

TABLE 2

| | Attributes/Array of | | | |
|---|---|---|---|---|
| MO | attributes | Size (bits) | Value/Note | Conditions |
| M | Ranging Purpose Indication | 4 | 0b0000 = it indicates that the AMS is | |
| | | | currently attempting network entry | |
| | | | 0b0001 = it indicates that the AMS is | |
| | | | currently attempting HO reentry | |
| | | | 0b0010 = it indicates that the AMS is | |
| | | | attempting network reentry from idle | |
| | | | mode to the ABS. | |
| | | | 0b0011 = it indicates that the AMS is | |
| | | | initiating the idle mode location | |
| | | | update process | |
| | | | 0b0100 = it indicates that the AMS is | |
| | | | initiating DCR mode extension. | |
| | | | 0b0101 = ranging request for emergency | |
| | | | (e.g. E911) call setup. When | |
| | | | this value is set, it indicates AMS | |
| | | | setion of Emergency Call process. | |
| | | | 0b0110 = it indicates that the AMS is | |
| | | | attempting to perform location update | |
| | | | due to a need to update service flow | |
| | | | management encodings for E-MBS | |
| | | | flows. | |
| | | | 0b0111 = it indicates that the AMS is | |
| | | | initiating location update for transition | |
| | | | to DCR mode from idle mode. | |
| | | | 0b1000 = it indicates that the AMS is | |
| | | | currently attempting reentry from | |
| | | | DCR mode coverage loss or detection | |
| | | | of the different ABS restart count. | |
| O | CRID | 72 | AMS identifier which the AMS has | It shall be |
| | | | been assigned for coverage loss or | included when |
| | | | DCR mode and are currently maintained. | the AMS is |
| | | | | attempting to |
| | | | | perform network |
| | | | | reentry |
| | | | | from coverage |
| | | | | loss or DCR |
| | | | | mode |
| | | | | or It shall be |
| | | | | included when |
| | | | | the AMS detects |
| | | | | the restart count |
| | | | | in AAI_SCD |
| | | | | message different |
| | | | | from old one |
| | | | | save in AMS. |

Fields suggested to perform this embodiment are only illustrated in Table 2, and the other fields may be the same as/similar to the AAI_RNG-REQ message format defined in the general IEEE 802.16 system. Referring to Table 2, if the ranging purpose indication field is set to 0b1000, it may indicate network re-entry due to DCR mode release, coverage loss recovery or restart of the base station. Also, if the restart count value included in the AAI_SCD message is different from that previously stored in the mobile station, the mobile station should necessarily include the CRID in the AAI_RNG-REQ message.

Table 3 illustrates a part of the AAI_RNG-REQ message format according to one embodiment of the present invention.

TABLE 3

| Name | Value | Usage |
|---|---|---|
| ~ | | |
| Ranging Purpose | The presence of this item in the message indicates the following AMS action: | It shall be included when the AMS is |
| Indication | If Bit#0 is set to 1, it indicates that the AMS is currently attempting HO reentry, or, in | attempting to perform reentry, HO, |
| | combination with a Paging Controller ID, indicates that the MS is attempting | location update or DCR mode extension. |
| | network reentry from idle mode to the BS. In this case, Bit#1 shall be 0. | |
| | If Bit#1 is set to 1, it indicates that the AMS is initiating the idle mode location update | |
| | process, or, in combination with CRID, it indicates that the AMS is initiating DCR | |
| | mode extension. In this case, Bit#0 shall be 0. | |
| | If Bit#2 is set to 1, ranging request for emergency call setup. When this bit is set to 1, | |
| | it indicates AMS action of Emergency Call process. | |
| | If Bit#4 is set to 1, it indicates that the AMS is attempting to perform location update | |
| | due to a need to update service flow management encodings for E-MBS flows. | |
| | If Bit #5 is set to 1, it indicates that the AMS is initiating location update for | |
| | transmission to DCR mode from idle mode. | |
| | If Bit #6 is set to 1 in combination with ID of the network entity that assigns/retains | |
| | the context, it indicates that the AMS is currently attempting reentry from DCR mode. | |
| | If Bit#7 is set to 1, it indicates that the AMS is currently attempting network reentry | |
| | after experiencing a coverage loss. | |
| | If Bit#8 is set to 1, it indicates that the AMS is currently attempting network reentry | |
| | from a IEEE802.16e only Legacy BS | |
| | If Bit#9 is set to 1, it indicates that the AMS is currently attempting network reentry | |
| | after detecting the different ABS restart count. | |
| CRID | AMS identifier which the AMS has been assigned for coverage loss or DCR mode and | It shall be included when the AMS is |
| | are currently maintained | attempting to perform network reentry from |
| | | coverage loss or DCR mode. |
| | | or |
| | | It shall be included when the AMS detects |
| | | the restart count in SCD message different |
| | | from old one save in AMS. |

Fields suggested to perform this embodiment are only illustrated in Table 3, and the other fields may be the same as/similar to the AAI_RNG-REQ message format defined in the general IEEE 802.16 system. Referring to Table 3, if the ranging purpose indication field is set to bit #9, it indicates that the mobile station is attempting network re-entry due to the different restart count values. Also, if the restart count value included in the AAI_SCD message is different from that previously stored in the mobile station, the mobile station should necessarily include the CRID in the AAI_RNG-REQ message.

The base station can perform the optimized network re-entry procedure by acquiring the connection information of the mobile station from the network entity that stores the connection information of the mobile station by using the CRID transmitted from the mobile station.

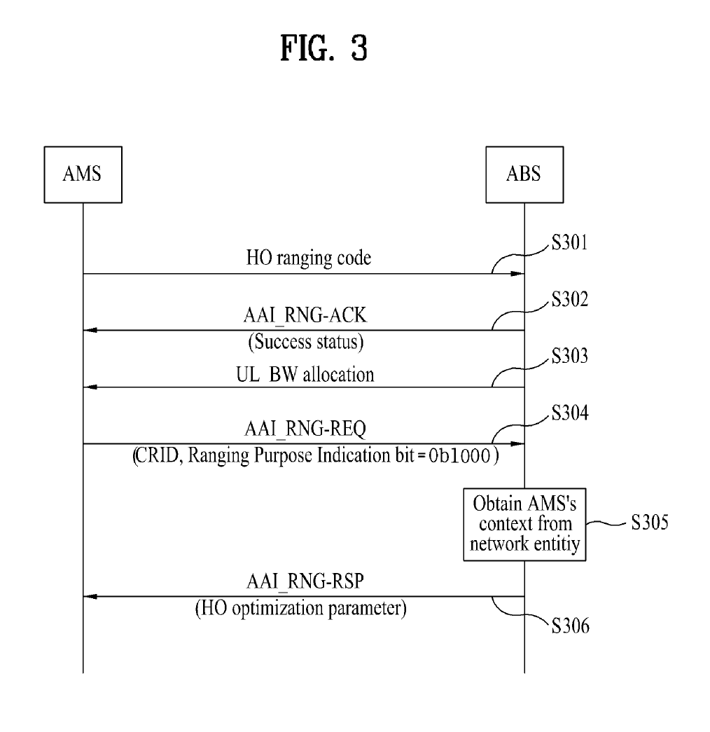

The aforementioned procedure of network re-entry will be described with reference to FIG. 3.

FIG. 3 is a diagram illustrating an example of a network re-entry procedure of a mobile station according to one embodiment of the present invention.

It is assumed that the procedure of FIG. 3 is subsequent to the procedure of FIG. 2.

If the mobile station determines restart of the base station, it can perform the network re-entry procedure. To this end, the mobile station transmits a handover (HO) ranging code to the base station (S301).

The base station successfully receives the ranging code, transmits the ranging acknowledgement (AAI_RNG-ACK) message to the mobile station by setting it to the success status, and allocates an uplink bandwidth (UL BW) to the mobile station (S302 and S303).

The mobile station transmits the ranging request message having a ranging purpose indicator, which is set to a value (for example, 0b1000) indicating network re-entry due to restart of the base station, to the base station through the allocated uplink resource (S304). At this time, the mobile station includes the CRID in the ranging request message, and protects the CRID using a cipher based message authentication code (CMAC) key generated as a new authentication key (AK) if security connection information is useful.

The base station can acquire the connection information of the mobile station by requesting the network entity (for example, authenticator ASN-GW) that stores the connection information of the corresponding mobile station by using the CRID transmitted through the ranging request message (S305).

The base station determines a MAC control message, which can be omitted, by using the acquired connection information of the mobile station and transmits the ranging response (AAI_RNG-RSP) message to the mobile station by setting a handover optimization parameter (S306).

In other words, the omissible procedure (signaling, control MAC message) is omitted through the HO (or Reentry) process optimization field of the AAI_RNG-RSP message, whereby the network re-entry procedure can be simplified.

At this time, the ranging response message may include station identifier (STID) for identifying the mobile station from the corresponding base station. If the CRID is updated, the ranging response message may further include new CRID. Also, if the CMAC value of the ranging request message transmitted from the mobile station is useful, the ranging response message can be encoded and transmitted to the mobile station.

The network re-entry procedure of the mobile station according to the embodiment of the present invention will again be described in brief. If the ABS restart count of the AAI_SCD message received from the base station is different from that previously stored in the mobile station, the mobile station determines coverage loss and performs a coverage loss recovery (i.e., network re-entry) procedure. At this time, the mobile station transmits the AAI_RNG-REQ message, which includes CRID, to the base station. And, the base station can optimize the network re-entry procedure based on the CRID. Afterwards, the mobile station can perform the network re-entry procedure in accordance with the optimization parameter.

Configuration of Mobile Station and Base Station

As another embodiment of the present invention, the mobile station and the base station through which the embodiments of the present invention can be carried out will be described.

The mobile station is operated as a transmitter in an uplink, whereas the mobile station is operated as a receiver in a downlink. Also, the base station is operated as a receiver in the uplink, whereas the base station is operated as a transmitter in the downlink. In other words, each of the mobile station and the base station can include a transmitter and a receiver for transmission and reception of information or data.

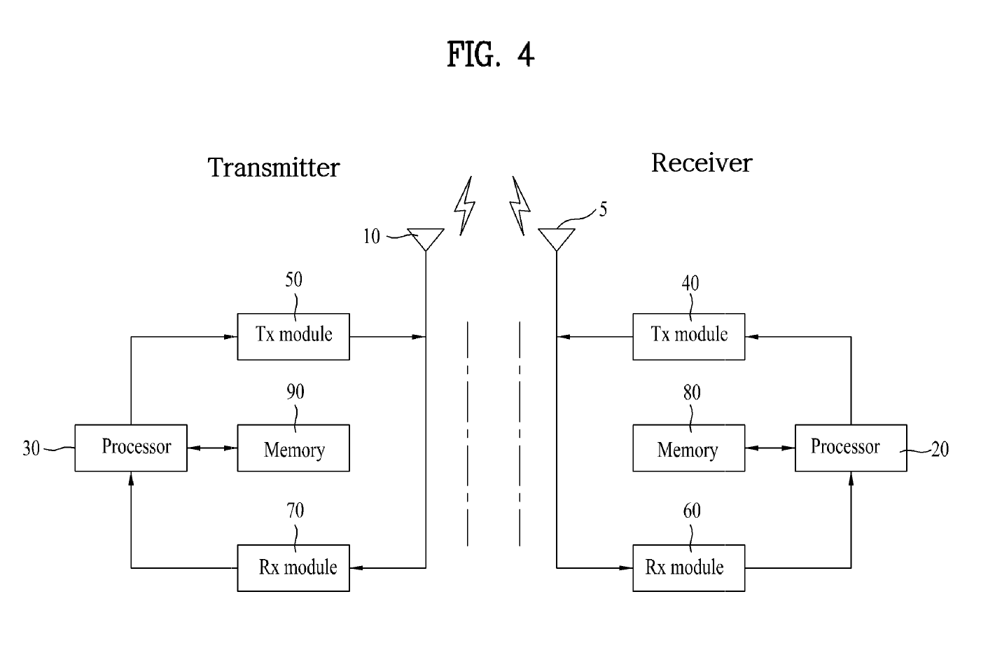

The transmitter and the receiver can include a processor, a module, a part, and/or a means, for which the embodiments of the present invention are carried out. In particular, the transmitter and the receiver can include a module (means) for encoding messages, a module for decoding the encoded messages, and an antenna for transmitting and receiving messages. An example of the transmitter and the receiver will be described with reference to FIG. 4.

FIG. 4 is a block diagram illustrating an example of a transmitter and a receiver according to other embodiment of the present invention.

Referring to FIG. 4, the left side represents a structure of the transmitter while the right side represents a structure of the receiver. Each of the transmitter and the receiver can include an antenna 5, 10, a processor 20, 30, a Tx module 40, 50, an Rx module 60, 70, and a memory 80, 90. The respective elements can perform functions corresponding to those of counterparts. Hereinafter, the respective elements will be described in more detail.

The antenna 5, 10 serves to transmit a signal generated by the Tx module 40, 50 to the outside or receive a radio signal from the outside to transfer the radio signal to the Rx module 60, 70. If a MIMO function is supported, two or more antennas may be provided.

The antenna, the Tx module, and the Rx module can constitute a radio frequency (RF) module.

The processor 20, 30 generally controls the whole operation of the mobile station. For example, the processor 20, 30 can perform a controller function for performing the aforementioned embodiments of the present invention, a medium access control (MAC) frame variable control function according to service characteristics and radio wave condition, a handover function, an authentication and encryption function, etc. In more detail, the processor 20, 30 can perform the whole control for detecting restart of the base station and performing the network re-entry procedure as illustrated in FIG. 2 and FIG. 3.

Particularly, the processor of the mobile station stores the restart count value if the AAI_SCD message broadcasted from the base station is received, and compares the stored value with the restart count value included in the AAI_SCD message received later. If the restart count values are different from each other, the processor of the mobile station determines that the base station is restarted.

If restart of the base station is detected. The processor of the mobile station transmits the ranging request message, which includes the ranging purpose indication field set to a value indicating network re-entry based on restart of the base station and CRID, to the corresponding base station. Afterwards, if the ranging response message is received from the base station, the processor of the mobile station can perform the optimized network re-entry procedure in accordance with the value of the handover (HO) process optimization field.

In addition, the processor of the mobile station can perform the whole control operation of the processes disclosed in the aforementioned embodiments.

The Tx module 40, 50 performs predetermined coding and modulation for data, which are scheduled from the processor 20, 30 and then transmitted to the outside, and then transfers the coded and modulated data to the antenna 10.

The Rx module 60, 70 performs decoding and demodulation for the radio signal received from the outside through the antenna 5, 10 to recover original data and then transfer the recovered data to the processor 20, 30.

The memory 80, 90 may store a program for processing and control of the processor 20, 30, or may perform a function for temporarily storing input/output data (restart count, etc.). Also, the memory 80, 90 can include at least one type of a flash memory type, a hard disk type, a multimedia card micro type, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

In the mean time, the base station can perform a control function for performing the aforementioned embodiments of the present invention, an orthogonal frequency division multiple access (OFDMA) packet scheduling, time division duplex (TDD) packet scheduling and channel multiplexing function, a medium access control (MAC) frame variable control function based on service characteristics and radio wave condition, a quick traffic real-time control function, a handover function, an authentication and encryption function, a packet modulation and demodulation function for data transmission, a quick packet channel coding function and a real-time modem control function through at least one of the aforementioned modules, or can further include a separate means, module, or part for performing the aforementioned functions.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

What is claimed is:

1. A method of performing network re-entry of a mobile station in a broadband wireless access system, the method comprising:
receiving a first message from a base station, the first message including a restart count of which value is varied whenever the base station restarts;
comparing the restart count value with a count value previously stored; and
transmitting a second message to the base station if the count values are different from each other, the second message including a first identifier for identifying the mobile station in respect of connection information (context) of the mobile station and a ranging purpose indication field set to a value indicating network re-entry due to the count difference.

2. The method of claim 1, further comprising receiving a third message from the base station, the third message including optimization information indicating a process that can be omitted during the network re-entry.

3. The method of claim 2, further comprising:
transmitting a handover ranging code to the base station;
receiving a fourth message from the base station, the fourth message including information regarding a ranging status of the handover ranging code; and
receiving uplink resource allocation information from the base station if the ranging status is success, wherein the transmission of a second message is performed using uplink resources indicated by the uplink resource allocation information.

4. The method of claim 3, wherein the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

5. The method of claim 2, wherein the first identifier is context retention identifier (CRID), the value indicating network re-entry due to the count difference is 0b1000, and the optimization information is a Reentry process optimization field.

6. A method of performing network re-entry of a base station in a broadband wireless access system due to restart of the base station, the method comprising:
restarting the base station;
increasing a restart count value;
broadcasting a first message, which includes the increased restart count value; and
receiving a second message from the mobile station, the second message including a first identifier for identifying the mobile station in respect of connection information (context) of the mobile station and a ranging purpose indication field set to a value indicating network re-entry due to the difference of the restart count value.

7. The method of claim 6, further comprising:
requesting a network entity, which stores the connection information of the mobile station, of the connection information of the mobile station; and
transmitting a third message to the mobile station, the third message including optimization information configured in accordance with the received connection information.

8. The method of claim 7, further comprising:
receiving a handover ranging code from the mobile station;
transmitting a fourth message to the mobile station, the fourth message including the information regarding a ranging status of the handover ranging code; and
transmitting uplink resource allocation information to the mobile station if the ranging status is success,
wherein the reception of a second message is performed using uplink resources indicated by the uplink resource allocation information.

9. The method of claim 8, wherein the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

10. The method of claim 8, wherein the first identifier is context retention identifier (CRID), the value indicating network re-entry due to the difference of the restart count value is 0b1000, and the optimization information is a Reentry process optimization field.

11. A mobile station of performing network re-entry in a broadband wireless access system, the mobile station comprising:
a processor; and
a radio frequency (RF) module for transmitting and receiving a radio signal to and from the outside under the control of the processor,
wherein, if a first message is received from a base station, the first message including a restart count of which value is varied whenever the base station restarts, the processor compares the restart count value with a count value previously stored, and transmits a second message to the base station if the count values are different from each other, the second message including a first identifier for identifying the mobile station in respect of connection information (context) of the mobile station and a ranging purpose indication field set to a value indicating network re-entry due to the difference of the restart count value.

12. The mobile station of claim 11, wherein the processor controls a third message to be received from the base station, the third message including optimization information indicating a process that can be omitted during the network re-entry.

13. The mobile station of claim 12, wherein the processor controls a handover ranging code to be transmitted to the base station and a fourth message to be received from the base station, the fourth message including information regarding a ranging status of the handover ranging code, and uplink resource allocation information to be received from the base station if the ranging status is success, the second message being transmitted to the base station through uplink resources indicated by the uplink resource allocation information.

14. The mobile station of claim 13, wherein the first message is a system configuration descriptor (AAI_SCD) message, the second message is a ranging request (AAI_RNG-REQ) message, the third message is a ranging response (AAI_RNG-RSP) message, and the fourth message is a ranging acknowledgement (AAI_RNG-ACK) message.

15. The mobile station claim 12, wherein the first identifier is context retention identifier (CRID), the value indicating network re-entry due to the difference of the restart count value is 0b1000, and the optimization information is a Reentry process optimization field.
